(19) United States
(12) Patent Application Publication
(10) Pub. No.: US 2024/0348723 A1
(43) Pub. Date: Oct. 17, 2024

(54) SYSTEMS AND METHODS FOR ENHANCING CUSTOMER EXPERIENCE

(71) Applicant: Engineer.ai Corp., Salt Lake City, UT (US)

(72) Inventors: Sachin Dev Duggal, Salt Lake City, UT (US); Srini Janarthanam, London (GB); Rohan Patel, London (GB); Priyanka Kochhar, London (GB)

(73) Assignee: Engineer.ai Corp., Salt Lake City, UT (US)

(21) Appl. No.: 18/300,384

(22) Filed: Apr. 13, 2023

(51) Int. Cl. H04M 3/42

(52) U.S. Cl. CPC H04M 3/42144

(57) ABSTRACT

Embodiments of the present disclosure relates to a computer system to enhance customer experience. The computer system includes a memory and a processor coupled to the memory. The processor is configured to receive one or more customer inputs while a customer is conversing with a user and predict a software application of interest for the customer based on the user inputs. The processor is also configured to generate a buildcard based on the predicted software application

### FIELD OF THE INVENTION

This disclosure relates to smart assistance systems. More particularly, the present disclosure relates to systems and methods for enhancing the customer experience.

### BACKGROUND

Generally, an assistant system provides information or services to a user using a search query input that the user supplies as user input. The user input can be text, especially in an instant messaging application or other applications, voice, images, or a combination. The assistant system may also perform one or more services without user initiation or interaction. However, the assistant system is not used in the software development application, especially when the customer expresses their idea and details of the application that needs to be developed. The assistant system may be very helpful when the customer is having an initial conversation with any software developer.

Accordingly, there is a need in the art to have an intelligent assistant system that analyzes the conversation between the customer and the software developer and provides instant recommendations and suggestions.

### SUMMARY

The disclosed subject matter includes systems, methods, and computer-readable storage mediums for enhancing in-call customer experience. A method includes receiving a notification about an intended call between a user and a customer and, while the call is in progress, identifying a conversation between the user and the customer to determine customer inputs. The method also includes determining the customer's intent based on the determined customer input and displaying one or more recommendations on a user device communication console while conversing with the customer.

Another general aspect is a computer system to enhance the in-call customer experience. The computer system includes a memory and a processor coupled to the memory. The processor is configured to receive a notification about an intended call between a user and a customer. The processor is also configured to identify a conversation between the user and the customer to determine customer inputs while the call is in progress. The processor is further configured to determine an intent of the customer based on the determined customer input and display one or more recommendations on a user device communication console while the user is conversing with the customer.

An exemplary embodiment is a computer readable storage medium having data stored therein representing software executable by a computer. The software includes instructions that, when executed, cause the computer readable storage medium to perform receiving a notification about an intended call between a user and a customer and identifying a conversation between the user and the customer to determine customer inputs while the call is in progress. The instructions may further cause the computer readable storage medium to perform determining an intent of the customer based on the determined customer input and displaying one or more recommendations on a user device communication console while the user is conversing with the customer.

Another general aspect is a method for standardizing communication. The method includes receiving a notification about an intended communication between a user and customer and identifying a conversation between the user and the customer while the communication is in progress. The method also includes determining one or more topics under discussion from the identified conversation and displaying one or more other topics as recommendations to the user for standardizing the communication.

An exemplary embodiment is a computer system to standardize communication. The computer system includes a memory and a processor coupled to the memory. The processor is configured to receive a notification about an intended communication between a user and customer and identify a conversation between the user and the customer while the communication is in progress. The processor is also configured to determine one or more topics under discussion from the identified conversation and display one or more other topics as recommendations to the user for standardizing the communication.

Another general aspect is a computer readable storage medium having data stored therein representing software executable by a computer. The software includes instructions that, when executed, cause the computer readable storage medium to perform receiving a notification about an intended communication between a user and customer and identifying a conversation between the user and the customer while the communication is in progress. The instructions may further cause the computer readable storage medium to perform determining one or more topics under discussion from the identified conversation and displaying one or more other topics as recommendations to the user for standardizing the communication.

Another exemplary embodiment is a method for enhancing customer experience. The method includes receiving one or more customer inputs while a customer is conversing with a user and predicting a software application of interest for the customer based on the one or more customer inputs. The method also includes generating a buildcard based on the predicted software application.

Another general aspect is a computer system to enhance customer experience. The computer system includes a memory and a processor coupled to the memory. The processor is configured to receive one or more customer inputs while a customer is conversing with a user and predict a software application of interest for the customer based on the user inputs. The processor is also configured to generate a buildcard based on the predicted software application.

An exemplary embodiment is a computer readable storage medium having data stored therein representing software executable by a computer. The software includes instructions that, when executed, cause the computer readable storage medium to perform receiving one or more customer inputs while a customer is conversing with a user and predicting a software application of interest for the customer based on the one or more customer inputs. The instructions may further cause the computer readable storage medium to perform generating a buildcard based on the predicted software application.

The systems, methods, and computer readable storage of the present disclosure overcome one or more of the shortcomings of the prior art. Additional features and advantages may be realized through the techniques of the present disclosure. Other embodiments and aspects of the disclosure are described in detail herein and are considered a part of the claimed disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the management components of the disclosed subject matter.

FIG. 3 is a schematic illustrating an embodiment of an assembly line and surfaces of the disclosed subject matter.

FIG. 4 is a schematic illustrating an embodiment of the run entities of the disclosed subject matter.

FIG. 5 is a schematic illustrating the computing components that may be used to implement various features of embodiments described in the disclosed subject matter.

FIG. 6 is a schematic illustrating a system in an embodiment of the disclosed subject matter.

FIG. 7 is a flow diagram illustrating a method for enhancing the in-call experience of customers in an embodiment of the disclosed subject matter.

FIG. 8 is a flow diagram illustrating a method for standardizing communication in an embodiment of the disclosed subject matter.

FIG. 9 is a flow diagram illustrating a method for enhancing customer experience in an embodiment of the disclosed subject matter.

### DETAILED DESCRIPTION

The disclosed subject matter comprises systems, methods, and computer readable storage mediums for enhancing in-call customer experience. A method includes receiving a notification about an intended call between a user and a customer and identifying a conversation between the user and the customer to determine customer inputs while the call is in progress. The method also includes determining the customer's intent based on the determined customer input and displaying one or more recommendations on a user device communication console while conversing with the customer.

Embodiments, of the present disclosure, will now be described with reference to the accompanying drawing. Embodiments are provided to convey the scope of the present disclosure thoroughly and fully to the person skilled in the art. Numerous details, are set forth, relating to specific components, and methods, to provide a complete understanding of embodiments of the present disclosure. It will be apparent to the person skilled in the art that the details provided in the embodiments may not be construed to limit the scope of the present disclosure. In some embodiments, well-known processes, apparatus structures, and techniques are not described in detail.

The terminology used, in the present disclosure, is to explain a particular embodiment and such terminology may not be considered to limit the scope of the present disclosure. As used in the present disclosure, the forms “a,” “an,” and “the” may be intended to include the plural forms as well, unless the context clearly suggests otherwise. The terms “comprises,” “comprising.” “including,” and “having,” are open ended transitional phrases and therefore specify the presence of stated features, elements, modules, units and/or components, but do not forbid the presence or addition of one or more other features, elements, components, and/or groups thereof. The particular order of steps disclosed in the method and process of the present disclosure is not to be construed as requiring their performance as described or illustrated. It is also to be understood that additional or alternative steps may be employed.

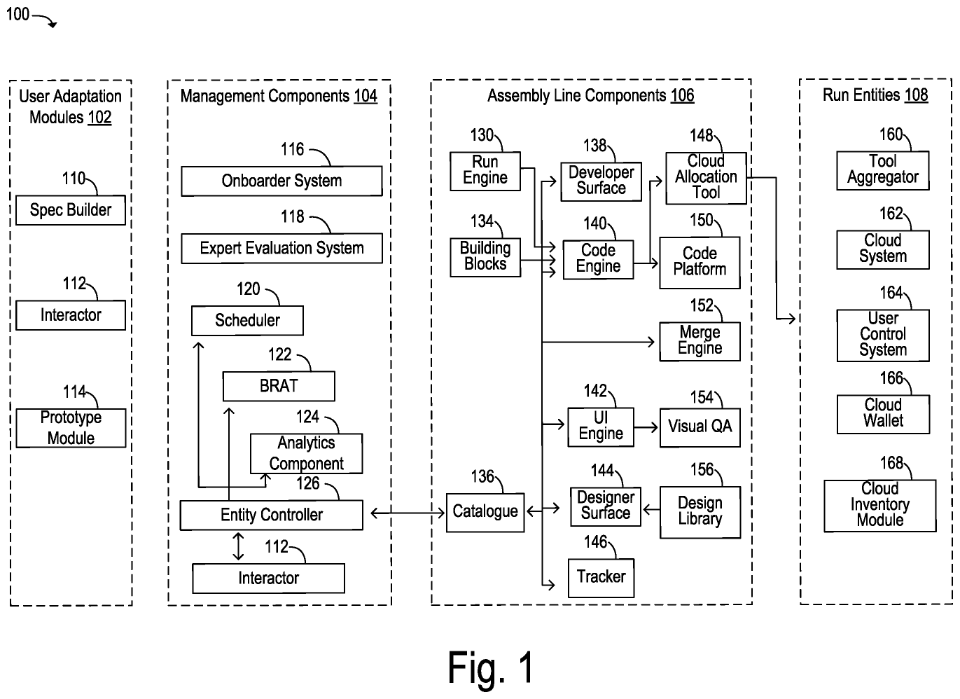

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user may leverage the various components of the software building system 100 to quickly design and complete a software project. The features of the software building system 100 operate AI algorithms where applicable to streamline the process of building software. Designing, building and managing a software project may all be automated by the AI algorithms.

To begin a software project, an intelligent AI conversational assistant may guide users in conception and design of their idea. Components of the software building system 100 may accept plain language specifications from a user and convert them into a computer readable specification that can be implemented by other parts of the software building system 100. Various other entities of the software building system 100 may accept the computer readable specification or buildcard to automatically implement it and/or manage the implementation of the computer readable specification.

The embodiment of the software building system 100 shown in FIG. 1 includes user adaptation modules 102, management components 104, assembly line components 106, and run entities 108. The user adaptation modules 102 entities guide a user during all parts of a project from the idea conception to full implementation. user adaptation modules 102 may intelligently link a user to various entities of the software building system 100 based on the specific needs of the user.

The user adaptation modules 102 may include specification builder 110, an interactor 112 system, and the prototype module 114. They may be used to guide a user through a process of building software and managing a software project. Specification builder 110, the interactor 112 system, and the prototype module 114 may be used concurrently and/or link to one another. For instance, specification builder 110 may accept user specifications that are generated in an interactor 112 system. The prototype module 114 may utilize computer generated specifications that are produced in specification builder 110 to create a prototype for various features. Further, the interactor 112 system may aid a user in implementing all features in specification builder 110 and the prototype module 114.

The specification builder 110 converts user supplied specifications into specifications that can be automatically read and implemented by various objects, instances, or entities of the software building system 100. The machine readable specifications may be referred to herein as a buildcard. In an example of use, specification builder 110 may accept a set of features, platforms, etc., as input and generate a machine readable specification for that project. Specification builder 110 may further use one or more machine learning algorithms to determine a cost and/or timeline for a given set of features. In an example of use, specification builder 110 may determine potential conflict points and factors that will significantly affect cost and timeliness of a project based on training data. For example, historical data may show that a combination of various building block components create a data transfer bottleneck. Specification builder 110 may be configured to flag such issues.

The interactor 112 system is an AI powered speech and conversational analysis system. It converses with a user with a goal of aiding the user. In one example, the interactor 112 system may ask the user a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases

In an exemplary embodiment, the NLP implemented by interactor 112 system is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation. Backpropagation is an algorithm used in neural networks to train models by adjusting the weights of the network to minimize the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP employed by the interactor 112 system may output the meaning of words and phrases that are communicated by the user. The interactor 112 system may then use the NLP output to comprehend conversational phrases and sentences to determine the relevant information related to the user's goals of a software project. Further machine learning algorithms may be employed to determine what kind of project the user wants to build including the goals of the user as well as providing relevant options for the user.

The prototype module 114 can automatically create an interactive prototype for features selected by a user. For instance, a user may select one or more features and view a prototype of the one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return best results.

The prototype module 114 may use a secondary machine learning algorithm to select a most likely starting screen for each prototype. Thus, a user may select one or more features and the prototype module 114 may automatically display a prototype of the selected features.

The software building system 100 includes management components 104 that aid the user in managing a complex software building project. The management components 104 allow a user that does not have experience in managing software projects to effectively manage multiple experts in various fields. An embodiment of the management components 104 include the onboarding system 116, an expert evaluation system 118, scheduler 120, BRAT 122, analytics component 124, entity controller 126, and the interactor 112 system.

The onboarding system 116 aggregates experts so they can be utilized to execute specifications that are set up in the software building system 100. In an exemplary embodiment, software development experts may register into the onboarding system 116 which will organize experts according to their skills, experience, and past performance. In one example, the onboarding system 116 provides the following features: partner onboarding, expert onboarding, reviewer assessments, expert availability management, and expert task allocation.

An example of partner onboarding may be pairing a user with one or more partners in a project. The onboarding system 116 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 116 to automatically review completed portions of a project. For instance, the onboarding system 116 may analyze submitted code, validate functionality of submitted code, and assess a status of the code repository. An example of expert availability management in the onboarding system 116 is to manage schedules for expert assignments and oversee expert compensation. An example of expert task allocation is to automatically assign jobs to experts that are onboarded in the onboarding system 116. For instance, the onboarding system 116 may determine a best fit to match onboarded experts with project goals and assign appropriate tasks to the determined experts.

The expert evaluation system 118 continuously evaluates developer experts. In an exemplary embodiment, the expert evaluation system 118 rates experts based on completed tasks and assigns scores to the experts. The scores may provide the experts with valuable critique and provide the onboarding system 116 with metrics with it can use to allocate the experts on future tasks.

Scheduler 120 keeps track of overall progress of a project and provides experts with job start and job completion estimates. In a complex project, some expert developers may be required to wait until parts of a project are completed before their tasks can begin. Thus, effective time allocation can improve expert developer management. Scheduler 120 provides up to date estimates to expert developers for job start and completion windows so they can better manage their own time and position them to complete their job on time with high quality.

The big resource allocation tool (BRAT 122) is capable of generating optimal developer assignments for every available parallel workstream across multiple projects. BRAT 122 system allows expert developers to be efficiently managed to minimize cost and time. In an exemplary embodiment, the BRAT 122 system considers a plethora of information including feature complexity, developer expertise, past developer experience, time zone, and project affinity to make assignments to expert developers. The BRAT 122 system may make use of the expert evaluation system 118 to determine the best experts for various assignments. Further, the expert evaluation system 118 may be leveraged to provide live grading to experts and employ qualitative and quantitative feedback. For instance, experts may be assigned a live score based on the number of jobs completed and the quality of jobs completed.

The analytics component 124 is a dashboard that provides a view of progress in a project. One of many purposes of the analytics component 124 dashboard is to provide a primary form of communication between a user and the project developers. Thus, offline communication, which can be time consuming and stressful, may be reduced. In an exemplary embodiment, the analytics component 124 dashboard may show live progress as a percentage feature along with releases, meetings, account settings, and ticket sections. Through the analytics component 124 dashboard, dependencies may be viewed and resolved by users or developer experts.

The entity controller 126 is a primary hub for entities of the software building system 100. It connects to scheduler 120, the BRAT 122 system, and the analytics component 124 to provide for continuous management of expert developer schedules, expert developer scoring for completed projects, and communication between expert developers and users. Through the entity controller 126, both expert developers and users may assess a project, make adjustments, and immediately communicate any changes to the rest of the development team.

The entity controller 126 may be linked to the interactor 112 system, allowing users to interact with a live project via an intelligent AI conversational system. Further, the Interactor 112 system may provide expert developers with up-to-date management communication such as text, email, ticketing, and even voice communications to inform developers of expected progress and/or review of completed assignments.

The assembly line components 106 comprise underlying components that provide the functionality to the software building system 100. The embodiment of the assembly line components 106 shown in FIG. 1 includes a run engine 130, building block components 134, catalogue 136, developer surface 138, a code engine 140, a UI engine 142, a designer surface 144, tracker 146, a cloud allocation tool 148, a code platform 150, a merge engine 152, visual QA 154, and a design library 156.

The run engine 130 may maintain communication between various building block components within a project as well as outside of the project. In an exemplary embodiment, the run engine 130 may send HTTP/S GET or POST requests from one page to another.

The building block components 134 are reusable code that are used across multiple computer readable specifications. The term buildcards, as used herein, refer to machine readable specifications that are generated by specification builder 110, which may convert user specifications into a computer readable specification that contains the user specifications and a format that can be implemented by an automated process with minimal intervention by expert developers.

The computer readable specifications are constructed with building block components 134, which are reusable code components. The building block components 134 may be pretested code components that are modular and safe to use. In an exemplary embodiment, every building block component 134 consists of two sections—core and custom. Core sections comprise the lines of code which represent the main functionality and reusable components across computer readable specifications. The custom sections comprise the snippets of code that define customizations specific to the computer readable specification. This could include placeholder texts, theme, color, font, error messages, branding information, etc.

Catalogue 136 is a management tool that may be used as a backbone for applications of the software building system 100. In an exemplary embodiment, the catalogue 136 may be linked to the entity controller 126 and provide it with centralized, uniform communication between different services.

Developer surface 138 is a virtual desktop with preinstalled tools for development. Expert developers may connect to developer surface 138 to complete assigned tasks. In an exemplary embodiment, expert developers may connect to developer surface from any device connected to a network that can access the software project. For instance, developer experts may access developer surface 138 from a web browser on any device. Thus, the developer experts may essentially work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 138 further provides a secure environment for developer experts to complete their assigned tasks.

The code engine 140 is a portion of a code platform 150 that assembles all the building block components required by the build card based on the features associated with the build card. The code platform 150 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the needed throughput based on the volume of builds coming in through a queue system. This stateless architecture may also enable support for multiple languages in a plug & play manner.

The cloud allocation tool 148 manages cloud computing that is associated with computer readable specifications. For example, the cloud allocation tool 148 assesses computer readable specifications to predict a cost and resources to complete them. The cloud allocation tool 148 then creates cloud accounts based on the prediction and facilitates payments over the lifecycle of the computer readable specification.

The merge engine 152 is a tool that is responsible for automatically merging the design code with the functional code. The merge engine 152 consolidates styles and assets in one place allowing experts to easily customize and consume the generated code. The merge engine 152 may handle navigations that connect different screens within an application. It may also handle animations and any other interactions within a page.

The UI engine 142 is a design-to-code product that converts designs into browser ready code. In an exemplary embodiment, the UI engine 142 converts designs such as those made in Sketch into React code. The UI engine may be configured to scale generated UI code to various screen sizes without requiring modifications by developers. In an example of use, a design file may be uploaded by a developer expert to designer surface 144 whereby the UI engine automatically converts the design file into a browser ready format.

Visual QA 154 automates the process of comparing design files with actual generated screens and identifies visual differences between the two. Thus, screens generated by the UI engine 142 may be automatically validated by the visual QA 154 system. In various embodiments, a pixel to pixel comparison is performed using computer vision to identify discrepancies on the static page layout of the screen based on location, color contrast and geometrical diagnosis of elements on the screen. Differences may be logged as bugs by scheduler 120 so they can be reviewed by expert developers.

In an exemplary embodiment, visual QA 154 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The visual QA 154 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 144 connects designers to a project network to view all of their assigned tasks as well as create or submit customer designs. In various embodiments, computer readable specifications include prompts to insert designs. Based on the computer readable specification, the designer surface 144 informs designers of designs that are expected of them and provides for easy submission of designs to the computer readable specification. Submitted designs may be immediately available for further customization by expert developers that are connected to a project network.

Similar to building block components 134, the design library 156 contains design components that may be reused across multiple computer readable specifications. The design components in the design library 156 may be configured to be inserted into computer readable specifications, which allows designers and expert developers to easily edit them as a starting point for new designs. The design library 156 may be linked to the designer surface 144, thus allowing designers to quickly browse pretested designs for user and/or editing.

Tracker 146 is a task management tool for tracking and managing granular tasks performed by experts in a project network. In an example of use, common tasks are injected into tracker 146 at the beginning of a project. In various embodiments, the common tasks are determined based on prior projects, completed, and tracked in the software building system 100.

The run entities 108 contain entities that all users, partners, expert developers, and designers use to interact within a centralized project network. In an exemplary embodiment, the run entities 108 include tool aggregator 160, cloud system 162, user control system 164, cloud wallet 166, and a cloud inventory module 168. The tool aggregator 160 entity brings together all third-party tools and services required by users to build, run and scale their software project. For instance, it may aggregate software services from payment gateways and licenses such as Office 365. User accounts may be automatically provisioned for needed services without the hassle of integrating them one at a time. In an exemplary embodiment, users of the run entities 108 may choose from various services on demand to be integrated into their application. The run entities 108 may also automatically handle invoicing of the services for the user.

The cloud system 162 is a cloud platform that is capable of running any of the services in a software project. The cloud system 162 may connect any of the entities of the software building system 100 such as the code platform 150, developer surface 138, designer surface 144, catalogue 136, entity controller 126, specification builder 110, the interactor 112 system, and the prototype module 114 to users, expert developers, and designers via a cloud network. In one example, cloud system 162 may connect developer experts to an IDE and design software for designers allowing them to work on a software project from any device.

The user control system 164 is a system requiring the user to have input over every feature of a final product in a software product. With the user control system 164, automation is configured to allow the user to edit and modify any features that are attached to a software project regardless as to the coding and design by developer experts and designer. For example, building block components 134 are configured to be malleable such that any customizations by expert developers can be undone without breaking the rest of a project. Thus, dependencies are configured so that no one feature locks out or restricts development of other features.

Cloud wallet 166 is a feature that handles transactions between various individuals and/or groups that work on a software project. For instance, payment for work performed by developer experts or designers from a user is facilitated by cloud wallet 166. A user need only set up a single account in cloud wallet 166 whereby cloud wallet handles payments of all transactions.

A cloud allocation tool 148 may automatically predict cloud costs that would be incurred by a computer readable specification. This is achieved by consuming data from multiple cloud providers and converting it to domain specific language, which allows the cloud allocation tool 148 to predict infrastructure blueprints for customers' computer readable specifications in a cloud agnostic manner. It manages the infrastructure for the entire lifecycle of the computer readable specification (from development to after care) which includes creation of cloud accounts, in predicted cloud providers, along with setting up CI/CD to facilitate automated deployments.

The cloud inventory module 168 handles storage of assets on the run entities 108. For instance, building block components 134 and assets of the design library are stored in the cloud inventory entity. Expert developers and designers that are onboarded by onboarding system 116 may have profiles stored in the cloud inventory module 168. Further, the cloud inventory module 168 may store funds that are managed by the cloud wallet 166. The cloud inventory module 168 may store various software packages that are used by users, expert developers, and designers to produce a software product.

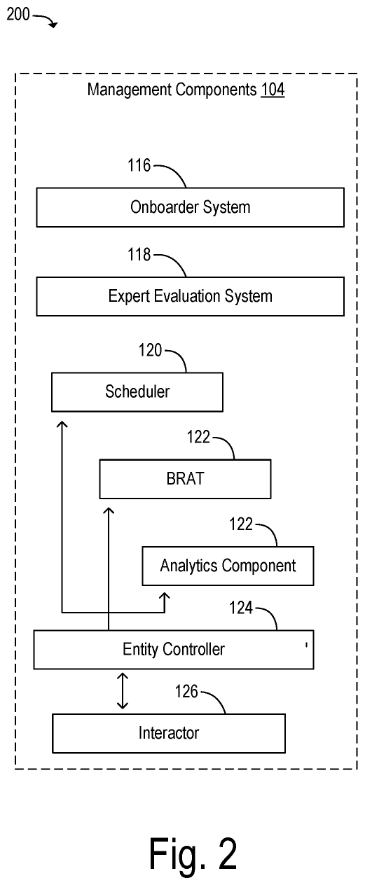

Referring to FIG. 2, FIG. 2 is a schematic 200 illustrating an embodiment of the management components 104 of the software building system 100. The management components 104 provide for continuous assessment and management of a project through its entities and systems. The central hub of the management components 104 is entity controller 126. In an exemplary embodiment, core functionality of the entity controller 126 system comprises the following: display computer readable specifications configurations, provide statuses of all computer readable specifications, provide toolkits within each computer readable specification, integration of the entity controller 126 with tracker 146 and the onboarding system 116, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all computer readable specifications may be displayed on the entity controller 126, which provides a concise perspective of the status of a software project. Toolkits provided in each computer readable specification allow expert developers and designers to chat, email, host meetings, and implement 3rd party integrations with users. Entity controller 126 allows a user to track progress through a variety of features including but not limited to tracker 146, the UI engine 142, and the onboarding system 116. For instance, the entity controller 126 may display the status of computer readable specifications as displayed in tracker 146. Further, the entity controller 126 may display a list of experts available through the onboarding system 116 at a given time as well as ranking experts for various jobs.

The entity controller 126 may also be configured to create code repositories. For example, the entity controller 126 may be configured to automatically create an infrastructure for code and to create a separate code repository for each branch of the infrastructure. Commits to the repository may also be managed by the entity controller 126.

Entity controller 126 may be integrated into scheduler 120 to determine a timeline for jobs to be completed by developer experts and designers. The BRAT 122 system may be leveraged to score and rank experts for jobs in scheduler 120. A user may interact with the various entity controller 126 features through the analytics component 124 dashboard. Alternatively, a user may interact with the entity controller 126 features via the interactive conversation in the interactor 112 system.

Entity controller 126 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 126. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

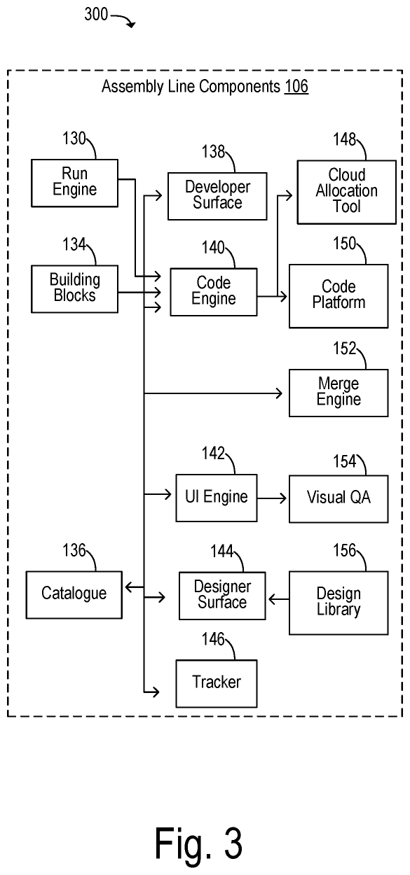

Referring to FIG. 3, FIG. 3 is a schematic 300 illustrating an embodiment of the assembly line components 106 of the software building system 100. The assembly line components 106 support the various features of the management components 104. For instance, the code platform 150 is configured to facilitate user management of a software project. The code engine 140 allows users to manage the creation of software by standardizing all code with pretested building block components. The building block components contain LSTs that identify the customizable portions of the building block components 134.

The machine readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The scheduler 120 may hire the expert developers based on the computer readable specifications or with direction from the user. Similarly, one or more designers may be hired based on specifications in a computer readable specification. Users may actively participate in management or take a passive role.

A cloud allocation tool 148 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 138 system provides an easy to set up platform within which expert developers can work on a software project. For instance, a developer in any geography may connect to a project via the cloud system 162 and immediately access tools to generate code. In one example, the expert developer is provided with a preconfigured IDE as they sign into a project from a web browser.

The designer surface 144 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 156. The design components, like building block components, allow the designers to start a design from a standardized design that is already functional.

The UI engine 142 may automatically convert designs into web ready code such as React code that may be viewed by a web browser. To ensure that the conversion process is accurate, the visual QA 154 system may evaluate screens generated by the UI engine 142 by comparing them with the designs that the screens are based on. In an exemplary embodiment, the visual QA 154 system does a pixel to pixel comparison and logs any discrepancies to be evaluated by an expert developer.

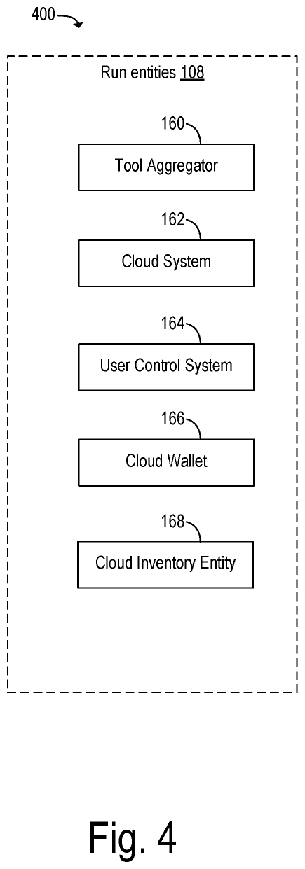

Referring to FIG. 4, FIG. 4 is a schematic 400 illustrating an embodiment of the run entities 108 of the software building system. The run entities 108 provides a user with 3^{rd} party tools and services, inventory management, and cloud services in a scalable system that can be automated to manage a software project. In an exemplary embodiment, the run entities 108 is a cloud-based system that provides a user with all tools necessary to run a project in a cloud environment.

For instance, the tool aggregator 160 automatically subscribes with appropriate 3^{rd} party tools and services and makes them available to a user without a time consuming and potentially confusing set up. The cloud system 162 connects a user to any of the features and services of the software project through a remote terminal. Through the cloud system 162, a user may use the user control system 164 to manage all aspects of a software project including conversing with an intelligent AI in the interactor 112 system, providing user specifications that are converted into computer readable specifications, providing user designs, viewing code, editing code, editing designs, interacting with expert developers and designers, interacting with partners, managing costs, and paying contractors.

A user may handle all costs and payments of a software project through cloud wallet 166. Payments to contractors such as expert developers and designers may be handled through one or more accounts in cloud wallet 166. The automated systems that assess completion of projects such as tracker 146 may automatically determine when jobs are completed and initiate appropriate payment as a result. Thus, accounting through cloud wallet 166 may be at least partially automated. In an exemplary embodiment, payments through cloud wallet 166 are completed by a machine learning AI that assesses job completion and total payment for contractors and/or employees in a software project.

Cloud inventory module 168 automatically manages inventory and purchases without human involvement. For example, cloud inventory module 168 manages storage of data in a repository or data warehouse. In an exemplary embodiment, it uses a modified version of the knapsack algorithm to recommend commitments to data that it stores in the data warehouse. Cloud inventory module 168 further automates and manages cloud reservations such as the tools providing in the tool aggregator 160.

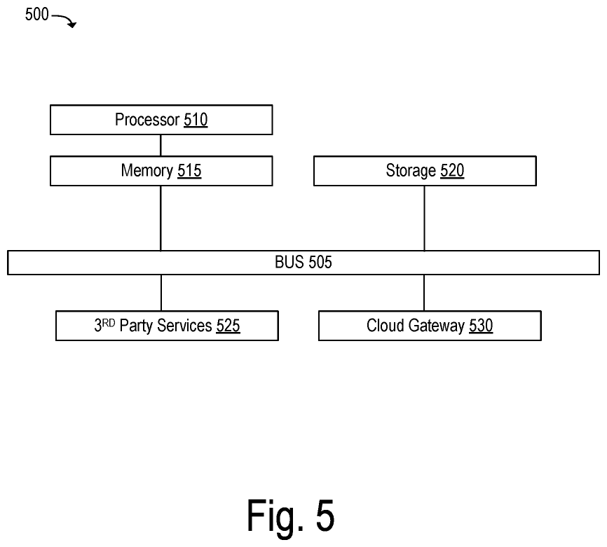

Referring to FIG. 5, FIG. 5 is a schematic illustrating a computing system 500 that may be used to implement various features of embodiments described in the disclosed subject matter. The terms components, entities, modules, surface, and platform, when used herein, may refer to one of the many embodiments of a computing system 500. The computing system 500 may be a single computer, a co-located computing system, a cloud-based computing system, or the like. The computing system 500 may be used to carry out the functions of one or more of the features, entities, and/or components of a software project.

The exemplary embodiment of the computing system 500 shown in FIG. 5 includes a bus 505 that connects the various components of the computing system 500, one or more processors 510 connected to a memory 515, and at least one storage 520. The processor 510 is an electronic circuit that executes instructions that are passed to it from the memory 515. Executed instructions are passed back from the processor 510 to the memory 515. The interaction between the processor 510 and memory 515 allow the computing system 500 to perform computations, calculations, and various computing to run software applications.

Examples of the processor 510 include central processing units (CPUs), graphics processing units (GPUs), field programmable gate arrays (FPGAs), complex programmable logic devices (CPLDs), and application specific integrated circuits (ASICs). The memory 515 stores instructions that are to be passed to the processor 510 and receives executed instructions from the processor 510. The memory 515 also passes and receives instructions from all other components of the computing system 500 through the bus 505. For example, a computer monitor may receive images from the memory 515 for display. Examples of memory include random access memory (RAM) and read only memory (ROM). RAM has high speed memory retrieval and does not hold data after power is turned off. ROM is typically slower than RAM and does not lose data when power is turned off.

The storage 520 is intended for long term data storage. Data in the software project such as computer readable specifications, code, designs, and the like may be saved in a storage 520. The storage 520 may be stored at any location including in the cloud. Various types of storage include spinning magnetic drives and solid-state storage drives.

The computing system 500 may connect to other computing systems in the performance of a software project. For instance, the computing system 500 may send and receive data from 3^{rd} party services such as Office 365 and Adobe. Similarly, users may access the computing system 500 via a cloud gateway 530. For instance, a user on a separate computing system may connect to the computing system 500 to access data, interact with the run entities 108, and even use 3^{rd} party services 525 via the cloud gateway.

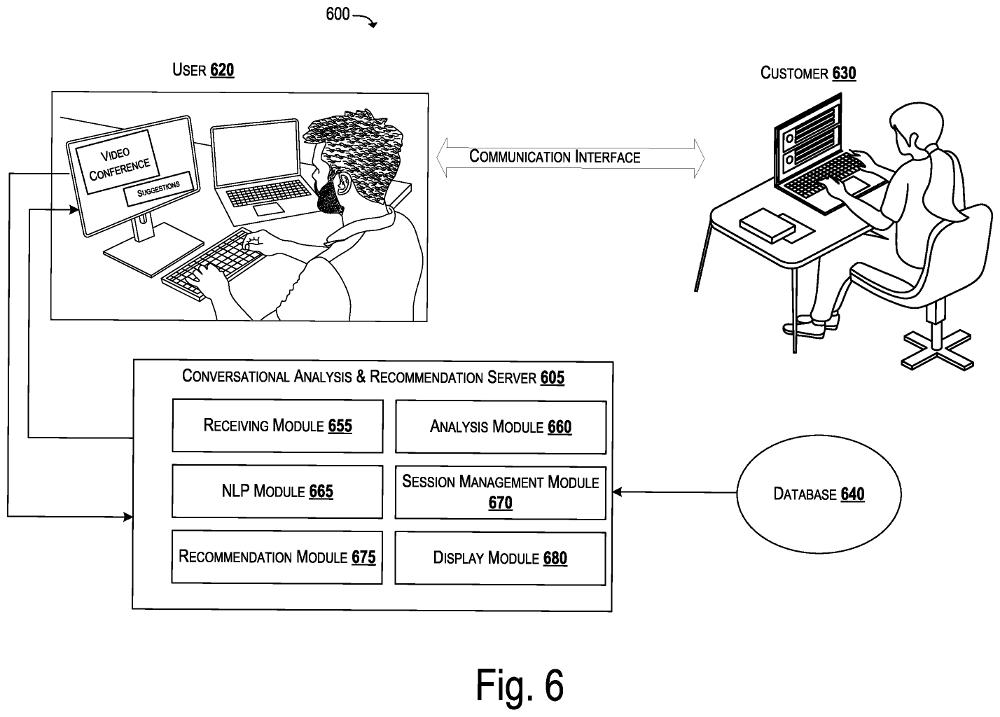

Referring to FIG. 6, FIG. 6 is a schematic diagram of a conversational analysis and recommendation system 600 in an embodiment of the disclosed subject matter. In an exemplary embodiment, the conversational analysis and recommendation system 600 comprises a conversational analysis and recommendation server 605, a user 620, a customer 630, and a database 640. The conversational analysis and recommendation server 605 may be a computing system 500 configured to operate the user adaptation modules 102, the management components 104, the assembly line components 106, and the run entities 108.

The conversational analysis and recommendation server 605 is configured to assist the user to improve the customer experience when the customer 630 is interacting with the user 620. In one embodiment, the user 620 can be a developer, a designer, a productologist, or any person of the organization. During each user 620 conversation with the customer 630, the conversational analysis and recommendation server 605 works as an assistant and provides the user 620 with one or more right questions to ask the customer 630. The conversational analysis and recommendation server 605 also listens to customer answers and performs one or more activities such as adding relevant features to generate a buildcard, providing future questions, and so on. With the help of the conversational analysis and recommendation server 605, every conversation with the customer 630 is standardized and the customer 630 communication with each user is precise and competent. as each user is provided real-time support with the assistance of the conversational analysis and recommendation server 605.

In one example, the conversational analysis and recommendation server 605 may be configured as a standalone system. The conversational analysis and recommendation server 605 also includes an interface provided therein for interacting with the data repository (or database) 640, such as the knowledge graph database. The conversational analysis and recommendation server 605 comprises one or more components coupled with each other that may be deployed on a single system or different systems. In an embodiment, the conversational analysis and recommendation server 605 comprises a receiving module 655, an analysis module 660, a natural language processing (NLP) module 665, a session management module 670, a recommendation module 675, a display module 680, and other modules 685 (not shown).

As used herein, the term module refers to an application-specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 685 may be used to perform various miscellaneous functionalities of the conversational analysis and recommendation server 605. It will be appreciated that such modules 685 may be represented as a single module or a combination of different modules.

In an embodiment, the receiving module 655 is configured to receive a notification about any scheduled communication such as a call, meeting, etc. The receiving module 655 may receive the notification about such intended communication using a calendar event of the user 620, a message in a device associated with the user 620, or any email communication. In any exemplary embodiment, the receiving module 655 may implement a crawler to receive the notifications.

In an embodiment, the analysis module 660 is coupled to the receiving module 655. The analysis module 660 comprises one or more speech recognition and text recognition modules installed in the device associated with the user 620. The analysis module 660 is configured to identify an ongoing conversation between the user 620 and the customer 630 by using one or more software programs or functions installed in the device associated with the user 620. The analysis module 660 is also configured to determine customer queries in the form of customer inputs from the identified conversation. In an exemplary embodiment, the analysis module 660 is configured to determine customer inputs by processing the conversation to an n-gram language model.

In an embodiment, the NLP module 665 is coupled to the analysis module 660. The NLP module 665 is configured to The NLP module 665 comprises one or more models, such as an intent classifier model, a feature tagging model, a feature recommendation model, an entity tagger model, a response classifier model, and a prompt mirroring model.

In an exemplary embodiment, the NLP module 665 is configured to determine an intent of the customer based on the determined customer inputs or queries. In one embodiment, the intent can be a question or an answer to an already raised question by the user 620. In an embodiment, the NLP module 665 is configured to generate one or more responses based on the determined intent and the customer input. Further, in one embodiment, the NLP module 665 is configured to encode the customer input and the one or more responses to obtain an encoded vectorial representation of the customer input and a plurality of encoded vectorial representations of the one or more responses.

In some embodiments, the NLP module 665 includes a ranking module that is configured to rank each of the one or more responses based on the plurality of encoded vectorial representations of the one or more responses. In any exemplary embodiment, in order to rank each of the one or more responses, the NLP module 665 includes a computation module that is configured to compute a dot product between the encoded vectorial representation of the customer input and the plurality of encoded vectorial representations of the one or more responses to obtain a score value for each of the one or more responses. Using the score value for each of the responses, the ranking module configured to rank each of the responses based on the computed score.

In an exemplary embodiment, the NLP module 665 includes a pre-trained language model that is trained before performing the encoding operation on the pre-trained language model via an encoder. The training operation performed on the encoder includes a pre-training and fine-tuning phases. In one embodiment, the pre-training phase includes pre-training the encoder according to a masked and permuted language modeling process. In the same embodiment, the fine-tuning phase includes training the pre-trained encoder according to a next-sentence prediction outcome task.

In some embodiments, the NLP module 665 is configured to identify one or more sections of the conversation based on the determined intent and the one or more customer inputs. In an exemplary embodiment, the NLP module 665 is configured to identify the one or more sections by processing the conversation to an n-gram language model. In one embodiment, the NLP module 665 is configured to run one or more models for the identified one or more sections of the conversation. For example, the feature tagging model is configured to determine or tag one or more features required for a software application based on the identified one or more sections. In another example, the feature recommendation model is configured to recommend one or more features required for the software application development based on the identified one or more sections. Similarly, in another example, the template recommendation model is configured to recommend one or more templates required for the software application development based on the identified one or more sections.

In one embodiment, the NLP module 665 is configured to compare the one or more sections with one or more standard topics. In one embodiment, the one or more standard topics can be a feature selection topic, a template selection topic, a complexity of project discussion topic, a timeline discussion topic, and a cost discussion topic. Upon the comparison, the NLP module 665 is configured to determine one or more topics under discussion based on the comparison. In one embodiment, the NLP module 665 is configured to update one or more status flags corresponding to the determined one or more topics as completed based on the determined one or more topics and store the updated one or more status flags in the database. In one embodiment, one or more status flags are associated with one or more standard topics. In one embodiment, the NLP module 665 is configured to use at least one of a dot product computation or a cosine similarity index for the comparison.

In one embodiment, the session management module 670 is configured to manage one or more sessions between the user 620 and the customer 630. In one embodiment, the session management module 670 is configured to auto-connect the user 650 and the customer 630 when any ongoing session between the user 620 and the customer 630 is disconnected or ended abruptly.

In one embodiment, the recommendation module 675 is coupled to the NLP module 665. The recommendation module 675 is configured to recommend a top-ranked response from the one or more responses. In another embodiment, the recommendation module 675 is configured to predict a software application based on the determined template. Further, the recommendation module 675 is also configured to generate the buildcard based on the predicted software application and the determined one or more features. Further, the recommendation module 675 is also configured to generate the complexity of the software application and a timeline required for developing the software application for the generated buildcard. The recommendation module 675 is configured to generate the complexity of the software application and the timeline needed by retrieving the historical data from the database and using one of the machine learning models from the NLP module 665.

In one embodiment, the display module 680 is coupled to the recommendation module 675. In one embodiment, the display module 680 is configured to display the one or more recommendations on a communication console of user device while the user 620 is conversing with the customer 630. In another embodiment, the display module 680 is configured to display the generated buildcard, the complexity of the software, and the timeline required while the user 620 is conversing with the customer 630. In another embodiment, the display module 680 is configured to display one or more other topics for the discussion as recommendations to have standardized communication with the customer 630, even by an inexperienced user. The standardized communication herein may refer to discussing each and every section that are required for the software application development without missing any section. Further, by displaying the recommendations on the display module 680, the user 620 can instantly give suggestions without having a delay when the conversation is going on with the customer 630.

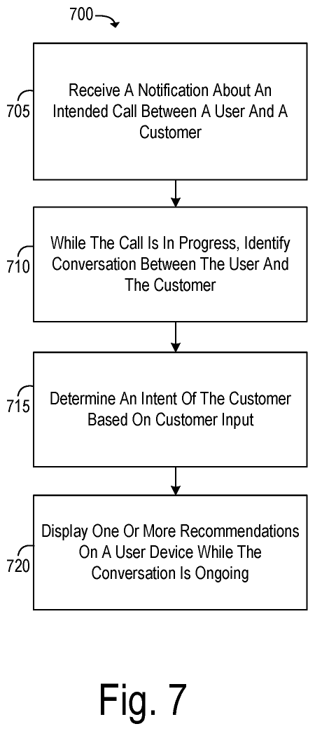

Referring to FIG. 7, FIG. 7 is a flow diagram 700 for an embodiment of a process of enhancing in-call customer experience. The process may be utilized by one or more modules in the conversational analysis and recommendation server 605 for enhancing in-call customer experience. The order in which the process/method 700 is described is not intended to be construed as a limitation, and any number of the described method blocks can be combined in any order to implement the method 700. Additionally, individual blocks may be deleted from the method 700 without departing from the spirit and scope of the subject matter described herein. Furthermore, the method 700 can be implemented in any suitable hardware, software, firmware, or combination thereof.

At step 705, the process may receive a notification about an intended call between the user 620 and the customer 630. In an embodiment, the receiving module 655 is configured to receive a notification about any scheduled communication such as a call, meeting, etc. The receiving module 655 may receive the notification about such intended communication using a calendar event of the user 620, a message in a device associated with the user 620, or any email communication. In any exemplary embodiment, receiving module 655 may implement a crawler to receive the notifications.

At step 710, the process may identify a conversation between the user 620 and the customer 630 while the call is in progress. In an embodiment, the analysis module 660 is coupled to the receiving module 655. The analysis module 660 comprises one or more speech recognition and text recognition modules installed in the device associated with the user 620. The analysis module 660 is configured to identify an ongoing conversation between the user 620 and the customer 630 by using one or more software programs or functions installed in the device associated with the user 620. The analysis module 660 is also configured to determine customer queries in the form of customer inputs from the identified conversation. In any exemplary embodiment, the analysis module 660 is configured to determine customer inputs by processing the conversation to an n-gram language model.

At step 715, the process may determine an intent of the customer based on the customer input. In an exemplary embodiment, the NLP module 665 is configured to determine an intent of the customer based on the determined customer inputs or queries. In one embodiment, the intent can be a question or an answer to an already question raised by the user 620.

At step 720, the process may display one or more recommendations on a user device while the conversation continues. In an embodiment, the NLP module 665 is configured to generate one or more responses based on the determined intent and the customer input. In one embodiment, the one or more responses are generated according to a knowledge graph. For example, the primary entity is determined from the customer input is determined and is located as a node of the knowledge graph. The one or more responses are identified as nodes connected to the node which is represented as the primary entity. The number of connections and type of connections for selecting the nodes connected to the node which is represented as the primary entity is determined based on the determined intent. In other embodiment, the contextual information is also taken into generated and appended to the one or more responses.

Further, in one embodiment, the NLP module 665 is configured to encode the customer input and the one or more responses to obtain an encoded vectorial representation of the customer input and a plurality of encoded vectorial representations of the one or more responses.

In some embodiments, the NLP module 665 includes a ranking module that is configured to rank each of the one or more responses based on the plurality of encoded vectorial representations of the one or more responses. In any exemplary embodiment, in order to rank each of the one or more response, the NLP module 665 includes a computation module that is configured to compute a dot product between the encoded vectorial representation of the customer input and the plurality of encoded vectorial representations of the one or more responses to obtain a score value for each of the one or more responses. Using the score value for each of the responses, the ranking module configured to rank each of the responses based on the computed score.

In an exemplary embodiment, the NLP module 665 includes a pre-trained language model that is trained before performing the encoding operation on the pre-trained language model via an encoder. The training operation performed on the encoder includes a pre-training and fine-tuning phases. In one embodiment, the pre-training phase includes pre-training the encoder according to a masked and permuted language modeling process. In the same embodiment, the fine-tuning phase includes training the pre-trained encoder according to a next-sentence prediction outcome task. Thereafter, the recommendation module 675 is configured to recommend a top-ranked response from the one or more responses and the display module 680 is configured to display the one or more recommendations on a communication console of user device while the user 620 is conversing with the customer 630.

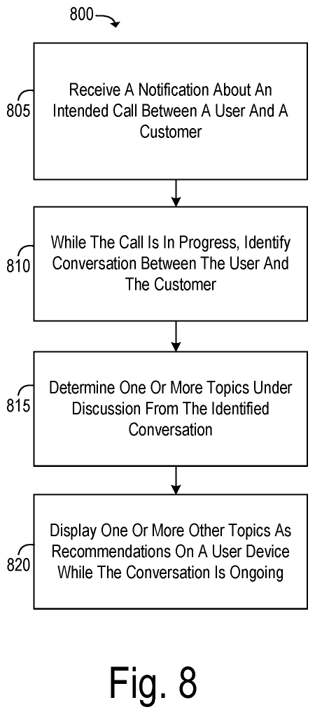

Referring to FIG. 8, FIG. 8 is a flow diagram 800 for an embodiment of a process of standardizing communication. The process may be utilized by one or more modules in the conversational analysis and recommendation server 605 for standardizing communication. The order in which the process/method 800 is described is not intended to be construed as a limitation, and any number of the described method blocks can be combined in any order to implement the method 800. Additionally, individual blocks may be deleted from the method 800 without departing from the spirit and scope of the subject matter described herein. Furthermore, the method 800 can be implemented in any suitable hardware, software, firmware, or combination thereof.

At step 805, the process may receive a notification about an intended call between the user 620 and the customer 630. In an embodiment, the receiving module 655 is configured to receive a notification about any scheduled communication such as a call, meeting, etc. The receiving module 655 may receive the notification about such intended communication using a calendar event of the user 620, a message in a device associated with the user 620, or any email communication. In any exemplary embodiment, receiving module 655 may implement a crawler to receive the notifications.

At step 810, the process may identify a conversation between the user 620 and the customer 630 while the call is in progress. In an embodiment, the analysis module 660 is coupled to the receiving module 655. The analysis module 660 comprises one or more speech recognition and text recognition modules installed in the device associated with the user 620. The analysis module 660 is configured to identify an ongoing conversation between the user 620 and the customer 630 by using one or more software programs or functions installed in the device associated with the user 620. The analysis module 660 is also configured to determine customer queries in the form of customer inputs from the identified conversation. In any exemplary embodiment, the analysis module 660 is configured to determine customer inputs by processing the conversation to an n-gram language model.

At step 815, the process may determine one or more topics under discussion from the identified conversation. In some embodiments, the NLP module 665 is configured to identify one or more sections of the conversation based on the determined intent and the one or more customer inputs. In any exemplary embodiment, the NLP module 665 is configured to identify the one or more sections by processing the conversation to an n-gram language model.

In one embodiment, the NLP module 665 is configured to compare the one or more sections with one or more standard topics. In one embodiment, the one or more standard topics can be a feature selection topic, a template selection topic, a complexity of project discussion topic, a timeline discussion topic, and a cost discussion topic. Upon the comparison, the NLP module 665 is configured to determine one or more topics under discussion based on the comparison. In one embodiment, the NLP module 665 is configured to update one or more status flags corresponding to the determined one or more topics as completed based on the determined one or more topics and store the updated one or more status flags in the database. In one embodiment, one or more status flags are associated with one or more standard topics. In one embodiment, the NLP module 665 is configured to use at least one of a dot product computation or a cosine similarity index for the comparison.

At step 820, the process may display one or more other topics as recommendations on the user device. In an embodiment, the display device 680 is configured to display one or more other topics for the discussion as recommendations to have standardized communication with the customer 630, even by an inexperienced user. Further, by displaying the recommendations on the display module 680, the user 620 can instantly give suggestions without delay when the conversation is going on with the customer 630. Upon displaying the one or more other topics for the discussion, the conversational analysis and recommendation server 605 continues listening to ongoing conversation between the user 620 and the customer 630 and determines that the ongoing conversation is initiated from the recommendations. Further, the conversational analysis and recommendation server 605 updates at least one of the one or more status flags related to the ongoing conversation as completed and recommends at least one of the one or more standard topics based on the updated status flag associated with each of the one or more standard topics. Thereafter, the conversational analysis and recommendation server 605 displays the one or more other topics based on the recommended at least one of the one or more standard topics and iterates the above steps until each of the status flags is updated as completed.

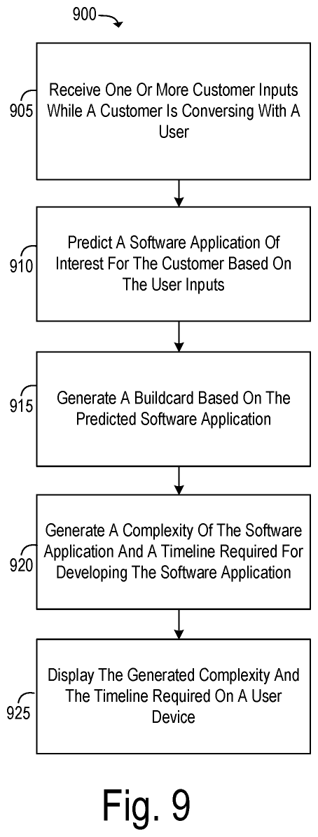

Referring to FIG. 9, FIG. 9 is a flow diagram 900 for an embodiment of a process of enhancing customer experience. The process may be utilized by one or more modules in the conversational analysis and recommendation server 605 for enhancing customer experience. The order in which the process/method 900 is described is not intended to be construed as a limitation, and any number of the described method blocks can be combined in any order to implement the method 900. Additionally, individual blocks may be deleted from the method 900 without departing from the spirit and scope of the subject matter described herein. Furthermore, the method 900 can be implemented in any suitable hardware, software, firmware, or combination thereof.

At step 905, the process may receive one or more customer inputs from the conversation between the user 620 and the customer 630 while the call is in progress. In an embodiment, the receiving module 655 comprises one or more speech recognition and text recognition modules installed in the device associated with the user 620. The receiving module 655 is configured to identify ongoing conversation between the user 620 and the customer 630 by using one or more software programs or functions installed in the device associated with the user 620.

At step 910, the process may predict a software application of interest for the customer based on the one or more customer inputs. In an exemplary embodiment, the NLP module 665 is configured to determine an intent of the customer based on the determined customer inputs or queries. In one embodiment, the intent can be a question or an answer to an already raised question by the user 620. In some embodiments, the NLP module 665 is configured to identify one or more sections of the conversation based on the determined intent and the one or more customer inputs. In an exemplary embodiment, the NLP module 665 is configured to identify the one or more sections by processing the conversation to an n-gram language model. In one embodiment, the NLP module 665 is configured to run one or more models for the identified one or more sections of the conversation. For example, the feature tagging model is configured to determine or tag one or more features required for a software application based on the identified one or more sections. In another example, the feature recommendation model is configured to recommend one or more features required for the software application development based on the identified one or more sections. Similarly, in another example, the template recommendation model is configured to recommend one or more templates required for the software application development based on the identified one or more sections. The recommendation module 675 is configured to predict a software application based on the determined template.

At step 915, the process may generate a buildcard based on the predicted software application. The recommendation module 675 is also configured to generate the buildcard based on the predicted software application and the determined one or more features.

At step 920, the process may generate a complexity of the software application and a timeline required for developing the software application. The recommendation module 675 is also configured to generate the complexity of the software application and a timeline required for developing the software application for the generated buildcard. The recommendation module 675 is configured to generate the complexity of the software application and the timeline required by retrieving the historical data from the database and using one of the machine learning models from the NLP module 665.

At step 925, the process may display the generated complexity of the software application and the timeline required for developing the software application. The display module 680 is also configured to display the generated complexity of the software application and the timeline required for developing the software application for the generated buildcard.

Thus, with the help of the methods explained above, the conversational analysis and recommendation server 605 standardize every conversation with the customer 630. Further, the customer 630 communication with each user is precise and competent, as each user is provided real-time support with the assistance of the conversational analysis and recommendation server 605.

Many variations may be made to the embodiments of the software project described herein. All variations, including combinations of variations, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A method for enhancing customer experience, the method comprising:
receiving one or more customer inputs while a customer is conversing with a user;
predicting a software application of interest for the customer based on the one or more customer inputs; and
generating a buildcard based on the predicted software application.

2. The method of claim 1, wherein predicting the software application comprises:
determining an intent of the customer based on the customer input using an intent classifier model;
identifying one or more sections of the conversation based on the determined intent and the one or more customer inputs;
running one or more models for the identified one or more sections of conversation; and
predicting the software application for the customer based on an output of the one or more models.

3. The method of claim 2, further comprises:
determining one or more templates intended by the customer for the software application based on the output of the one or more models; and
predicting the software application of interest for the customer based on the determined one or more templates.

4. The method of claim 3, wherein generating the buildcard comprises:
determining one or more features intended by the customer based on the output of the one or more models; and
generating the buildcard based on the predicted software application and the determined one or more features.

5. The method of claim 2, wherein the one or more models comprises at least one of a feature tagging model, a feature recommendation model, a template recommendation model, an entity tagger model, a response classifier model, and a prompt mirroring model.

6. The method of claim 1, further comprises:
generating a complexity of the software application and a timeline required for developing the software application based on the generated buildcard; and
displaying the generated complexity of the application and the timeline required on a user device communication console while the user is conversing with the customer.

7. The method of claim 6, wherein generating the complexity of the software application and the timeline required for developing the software application comprises:
retrieving the historical data from a database;
selecting a machine learning model from a plurality of machine learning models, wherein each of the plurality of machine learning models includes a Light Gradient Boosting model;
inputting the historical data and the generated buildcard to the selected machine learning model; and
generating the complexity of the software application and the timeline required for developing the software application based on an output of the selected machine learning model.

8. A computer system to enhance customer experience, the computer system comprises:
a memory; and
a processor coupled to the memory and configured to:
receive one or more customer inputs while a customer is conversing with a user;
predict a software application of interest for the customer based on the user inputs; and
generate a buildcard based on the predicted software application.

9. The computer system of claim 8, wherein to predict the software application, the processor is configured to:
determine an intent of the customer based on the customer input using an intent classifier model;
identify one or more sections of conversation based on the determined intent and user input
run one or more models for the identified one or more sections of conversation; and
predict the software application for the customer based on an output of the one or more models.

10. The computer system of claim 9, wherein the processor is further configured to:
determine one or more templates intended by the customer for the software application based on the output of the one or more models; and
predict the software application of interest for the customer based on the determined one or more templates.

11. The computer system of claim 10, wherein to generate the buildcard, the processor is configured to:
determine one or more features intended by the customer based on the output of the one or more models; and
generate the buildcard based on the predicted software application and the determined one or more features.

12. The computer system of claim 9, wherein the one or more models comprises at least one of a feature tagging model, a feature recommendation model, a template recommendation model, an entity tagger model, a response classifier model, and a prompt mirroring model.

13. The computer system of claim 8, wherein the processor is further configured to:
generate a complexity of the software application and a timeline required for developing the software application based on the generated buildcard; and
display the generated complexity of the application and the timeline required on a user device communication console while the user is conversing with the customer.

14. The computer system of claim 13, wherein to generate the complexity of the software application and the timeline required for developing the software application, the processor is configured to:
retrieve the historical data from a database;
select a machine learning model from a plurality of machine learning models, wherein each of the plurality of machine learning models includes a Light Gradient Boosting model;
input the historical data and the generated buildcard to the selected machine learning model; and
generate the complexity of the software application and the timeline required for developing the software application based on an output of the selected machine learning model.

15. A computer readable storage medium having data stored therein representing software executable by a computer, the software comprising instructions that, when executed, cause the computer readable storage medium to perform:
receiving one or more customer inputs while a customer is conversing with a user;
predicting a software application of interest for the customer based on the one or more customer inputs; and
generating a buildcard based on the predicted software application.

16. The computer readable storage medium of claim 15, wherein predicting the software application comprises:
determining an intent of the customer based on the customer input using an intent classifier model;
identifying one or more sections of the conversation based on the determined intent and the one or more customer inputs;
running one or more models for the identified one or more sections of conversation; and
predicting the software application for the customer based on an output of the one or more models.

17. The computer readable storage medium of claim 16, further comprises:
determining one or more templates intended by the customer for the software application based on the output of the one or more models; and
predicting the software application of interest for the customer based on the determined one or more templates.

18. The computer readable storage medium of claim 17, wherein generating the buildcard comprises:
determining one or more features intended by the customer based on the output of the one or more models; and
generating the buildcard based on the predicted software application and the determined one or more features.

19. The computer readable storage medium of claim 16, wherein the one or more models comprises at least one of a feature tagging model, a feature recommendation model, a template recommendation model, an entity tagger model, a response classifier model, and a prompt mirroring model.

20. The computer readable storage medium of claim 15, further comprises:
generating a complexity of the software application and a timeline required for developing the software application based on the generated buildcard; and
displaying the generated complexity of the application and the timeline required on a user device communication console while the user is conversing with the customer.
